(19) United States
(12) Patent Application Publication
(10) Pub. No.: US 2015/0202850 A1
(43) Pub. Date: Jul. 23, 2015

(54) DEVICE FOR APPLYING A PROTECTIVE FILM ONTO THE SURFACE OF AN ITEM, MORE PARTICULARLY ONTO THE DISPLAY OF AN ELECTRONIC DEVICE

(71) Applicant: Vigano' Servizi S.R.L., Milano Marittima (RA) (IT)

(72) Inventor: Philip Pasini, Milano Marittima (RA) (IT)

(21) Appl. No.: 14/420,940

(22) PCT Filed: Aug. 8, 2013
(86) PCT No.: PCT/IB2013/056485

§ 371 Date: Feb. 11, 2015

(30) Foreign Application Priority Data
Aug. 14, 2012 (IT) TO2012A000729

(51) Int. Cl. B32B 37/00

(52) U.S. Cl. CPC B32B 37/0046; B32B 2457/20

(57) ABSTRACT

A device for applying a protective film onto a surface of an item, more particularly, a device for applying an electrostatic adhesion protective film onto the display of an electronic device, such as a mobile phone, tablet, or the like is provided. The device (1;11;21;21′) comprises a mount (3;13;23;23′) having an outer perimeter frame (3b;13b;23b;23b′), the shape of the item onto which the protective film is to be applied or a portion thereof being partially or completely defined within the frame, and one or more delimiting blocks (5;15;25;25′) protruding from the frame (3b;13b;23b;23b′) and holding the item within the frame and in contact with it. Due to the structure of the device (1;11;21;21′), the item is firmly and accurately maintained in position and the protective film can be easily applied thereto in correct position with correct alignment via a first attempt without risk of formation of wrinkles and air bubbles.

### TECHNICAL FIELD

The present invention relates to a device for applying a protective film onto the surface of an item.

More particularly, the present invention relates to a device for applying a protective film onto the display of an electronic device, such as a mobile phone, a tablet or the like.

### PRIOR ART

Nowadays, electronic devices such as mobile phones, namely touch screen mobile phones, tablet personal computers and the like are widely available.

It is evident that in such electronic devices the display, also in view of its small size, has to be maintained under conditions that ensure to the user a comfortable and effortless reading of the displayed data.

It is also evident that, on the other hand, said displays are subjected to scratches, abrasions, accumulation of dust and dirt, which deteriorate their performance in terms of readability of the displayed data.

For this reason, transparent films are often associated to the display of the above-mentioned electronic devices, which films protect said displays from scratches and dust and may also possibly have anti-glare properties so as to ensure a good readability of the displayed data in any lighting condition of the surrounding environment.

In general, such protective films are electrostatic adhesion films, i.e. they comprise an electrostatic layer that ensures the adhesion to the display without the use of glues or other product that could leave a residue.

The electronic devices are typically sold with such a protective film.

Moreover, since the film, after a certain period of use, deteriorates and needs to be replaced, protective films are also sold separately, whereby the user can replace the film whenever it is necessary.

However, the manual application of such protective films onto the display of an electronic device is not easy to perform.

Indeed, it is important to correctly position and align the protective film on the display at the first attempt, since the need to reposition several time the film on the display involves the risk of deteriorating the adhesion properties of said film, thus jeopardizing its firmness.

By the way, the formation of wrinkles and/or air bubbles between the protective film and the underlying display significantly affects the final result, as said wrinkles and/or air bubbles successively represent an annoying obstacle when reading the data displayed on the display.

Moreover, the presence of wrinkles and/or air bubbles negatively affects the tightness of the protective film, drastically reducing its life, before replacement becomes required.

Therefore, there is the need to provide a device which allows any user to correctly apply the protective film onto the display of an electronic device, irrespective of his/her manual dexterity.

An object of the present invention is therefore to provide a device and a method allowing to apply a protective film onto a surface in the correct position and with the correct alignment at the first attempt and without the formation of wrinkles or air bubbles.

Another object of the present invention is to provide a device for applying a protective film onto a surface which is as simple and inexpensive as possible.

These and other objects are achieved by the device as claimed in the appended claims.

### DISCLOSURE OF THE INVENTION

The device according to the invention essentially comprises a mount, comprising an outer perimeter frame, within which the shape of the item onto which the protective film is to be applied is partially or completely defined, and one or more delimiting blocks protruding from said outer perimeter frame and holding the item within said frame and in contact with it.

Said mount may also possibly comprise a background wall acting as a supporting surface for the aforesaid item.

Thanks to the structure of the device according to the invention, the item onto which the protective film is to be applied is firmly and accurately maintained in position and the protective film can therefore be easily applied, in the correct position and with the correct alignment, at the first attempt and without the risk of forming wrinkles and/or air bubbles.

Despite the extreme simplicity of the device according to the invention, practical tests have shown that by using said device the application of protective films, especially onto displays of electronic devices, is considerably improved, thus making this application easier, quicker and free from imperfections.

### BRIEF DESCRIPTION OF THE DRAWINGS

Advantages and features of the invention will be more evident from the following detailed description of some preferred embodiments of the invention itself, given by way of non-limiting example, with reference to the accompanying drawings, wherein:

FIG. 1 is a front view of a device for applying a protective film according to a first embodiment of the invention;

FIG. 2 is a side view of the device of FIG. 1;

FIG. 3 is a front view of a device for applying a protective film according to a second embodiment of the invention;

FIG. 4 is a top view of the device of FIG. 3;

FIG. 5 is a front view of a device for applying a protective film according to a third embodiment of the invention;

FIG. 6 is a front view of a device for applying a protective film according to a variant of the third embodiment of the invention.

### DESCRIPTION OF SOME PREFERRED EMBODIMENTS OF THE INVENTION

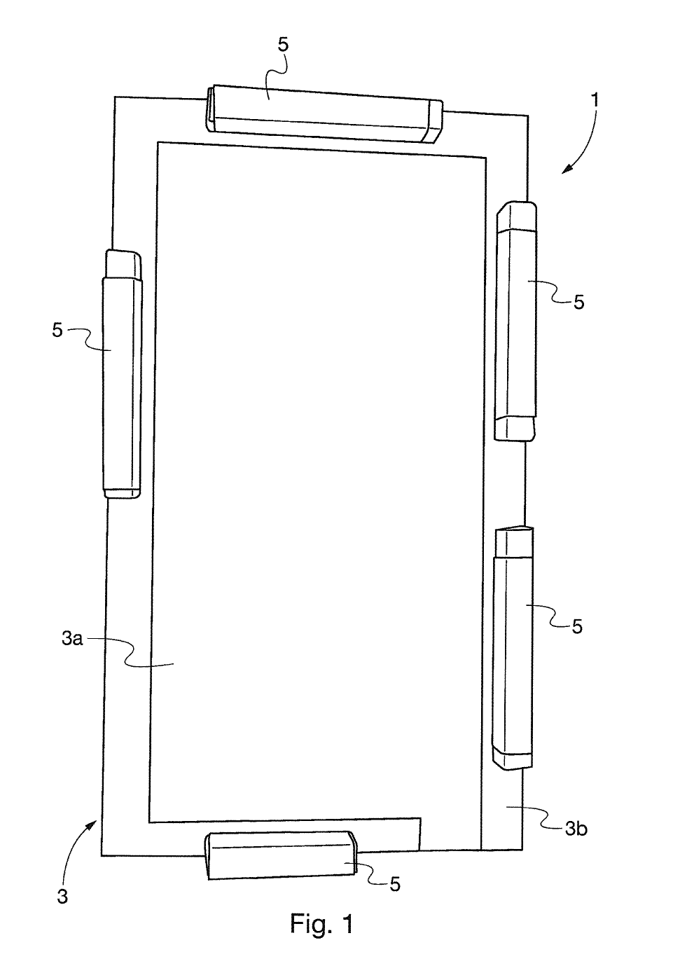

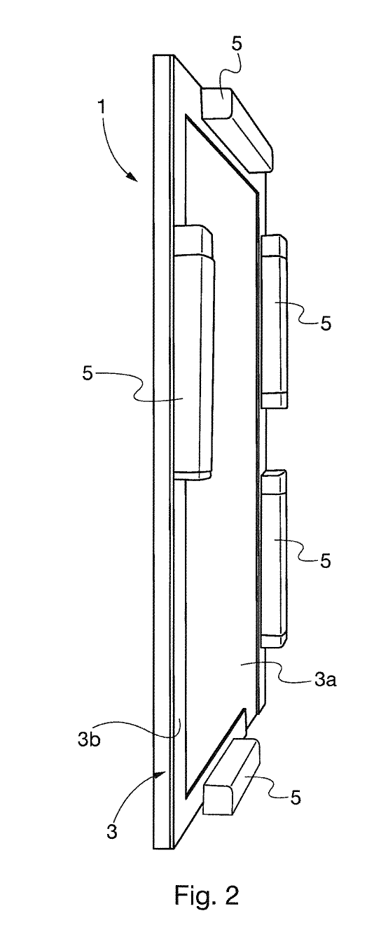

With reference to FIGS. 1 and 2, a device for applying protective films according to a first embodiment of the invention is shown, said device as a whole being indicated by reference 1.

The device 1 includes a mount 3 comprising an outer perimeter frame 3b, the shape and size of said frame 3b being chosen so that the shape of the item onto which the protective film is to be applied, such as for instance a mobile phone or a tablet personal computer, is defined within said frame.

More particularly, according to this first embodiment of the invention the whole shape of said item is defined within said perimeter frame 3b.

Moreover, according to this first embodiment of the invention, the mount 3 further comprises a background wall 3a, extending within the perimeter frame 3b and acting as a supporting surface for the aforesaid item when the latter is placed inside said frame 3b.

The device 1 further comprises one or more delimiting blocks 5 arranged along the perimeter of the frame 3b and protruding therefrom, said blocks allowing to hold the above-mentioned item within the frame 3b.

In the example shown in FIGS. 1 and 2, five delimiting blocks 5 are provided, which are discretely arranged along the perimeter of the frame 3b.

More particularly, in the example shown in FIGS. 1 and 2, the frame 3b has a rectangular outline and at least a delimiting block 5 having a rectilinear shape is provided on each side of said frame.

It is evident that delimiting blocks having different shapes and provided in different number could also be envisaged.

For example, delimiting blocks having corner-like shape could be provided at each corner of the frame 3b or even at two opposite corners of said frame only.

Still, a single delimiting block extending along the whole perimeter of the frame 3b, or along a portion of said perimeter sufficient for ensuring the proper retention of the item within the frame itself, could be provided.

According to a possible way of exploiting the invention, the method for applying a protective film onto the surface of an item—namely onto the display of an electronic device—by using the above-disclosed device 1 will be evident to the person skilled in the art:
the item is inserted into the device 1, within the frame 3b of the mount 3, where it is firmly held by the delimiting blocks 5, with the surface onto which the protective film is to be applied being accessible from the outside (i.e. oriented in the direction opposite to the supporting surface 3a);
an electrostatic adhesion film is freed from the backing sheet associated therewith, if any, and placed onto the corresponding surface of the aforesaid item, with the electrostatic layer facing towards the surface of said item.

The film is preferably applied onto said surface through a translational displacement in the direction perpendicular to the surface onto which it is to be applied (i.e. through a movement similar to the movement for affixing a stamp).

According to another possible way of using the invention, the method for applying a protective film onto the surface of an item—namely onto the display of an electronic device—by using the above-disclosed device 1 will be evident as well:
an electrostatic adhesion film is freed from the backing sheet associated therewith, if any, and placed into the frame 3b of the mount 3, where it is maintained in position by the delimiting blocks 5, with the electrostatic adhesion surface facing upwards;
the aforesaid item, with the display facing downwards, is inserted into the device 2, within the frame 3b of the mount 3, where it is guided by the delimiting blocks 5, and it is pressed against the film housed in said device 1.

As clearly visible in FIGS. 1 and 2, this embodiment is made possible by the fact that, on the inner side with respect to the delimiting blocks 5, the frame 3b of the mount 3 has a free border that can be used as a housing or seat for the protective film.

As mentioned before, practical tests have proven that using the device allows to apply protective films without wrinkles and air bubbles and in an extremely quick and accurate way.

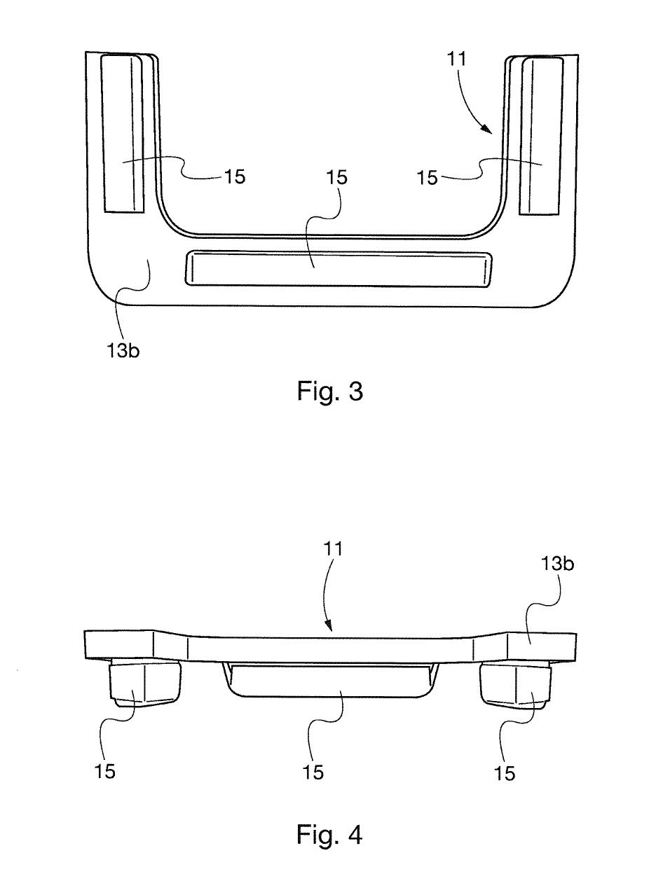

Turning now to FIGS. 3 and 4, a device for applying protective films according to a second embodiment of the invention is shown, said device as a whole being indicated by reference 11.

Also in this case, the device 11 according to the invention includes a mount 13 comprising an outer perimeter frame 13b; however, according to this second embodiment the shape and size of said frame 13b are chosen so that only a portion of the shape of the item onto which the protective film is to be applied is defined within said frame.

More particularly, in the example shown in FIGS. 3 and 4, the frame 13b has a “U”-shaped outline and it is suitable for housing an end portion of an item, such as a mobile phone or a tablet personal computer.

Also in this embodiment, the device 11 further comprises one or more delimiting blocks 15 arranged along the perimeter of the frame 13b and protruding therefrom, thus allowing to obtain a seat for the above-mentioned item within the frame 13b.

In the example shown in FIGS. 3 and 4, three delimiting blocks 15 are provided, which are discretely arranged along the perimeter of the frame 13b; more particularly, said delimiting blocks 5 have a rectilinear shape and each of them is arranged on a respective side of the “U”-shaped frame 13b.

As an alternative, two delimiting blocks having corner-like shape could be provided each at each corner of the frame 13b or even a single delimiting block extending along the whole perimeter of the frame 13b, or along a substantial portion thereof could be provided.

Also in this case, as described above with reference to the first embodiment of the invention, a possible method for applying a protective film onto the surface of an item comprises the steps of inserting the item into the device 11, within the frame 13b of the mount 13, with the surface onto which the protective film is to be applied being accessible from the outside and of positioning an electrostatic adhesion film onto the corresponding surface of the aforesaid item, with the electrostatic layer facing towards the surface of said item.

Also in this case, another possible method for applying a protective film onto the item 1 comprises the steps of placing an electrostatic adhesion film into the device 11, on the frame 13b of the mount 13 and within the delimiting blocks 15, with the electrostatic adhesion surface facing upwards, and of successively inserting the aforesaid item into the device 11, with the surface onto which the protective film is to be applied facing downwards.

As clearly visible in particular in FIG. 3, also in this embodiment a seat or housing for a corresponding portion of a protective film is defined on the frame 13b of the mount 13, on the inner side with respect to the delimiting blocks 15.

Practical tests have proven that also in this case using the device 11 allows to apply protective films in the correct position and with the correct alignment at the first attempt, without wrinkles and air bubbles and in an extremely quick and accurate way.

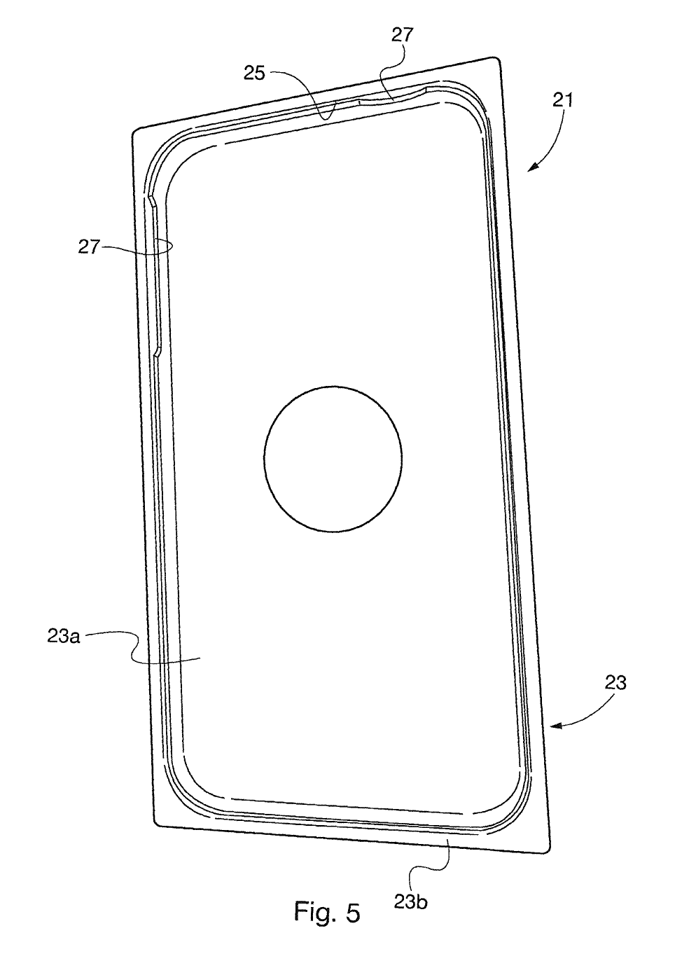

Turning now to FIG. 5, a device 21 for applying protective films according to a third embodiment of the invention is shown.

Said device 21 is substantially similar to the device shown in FIGS. 1 and 2 and it includes a mount 23 comprising an outer perimeter frame 23b, the shape and size of said frame 23b being chosen so that the shape of the item onto which the protective film is to be applied is defined within said frame, and a background wall 23a extending within the perimeter frame 23b.

The device 21 differs from the device shown in FIGS. 1 and 2 in that it comprises a single delimiting block 25 extending along the whole perimeter of the frame 23b and substantially forming a second raised frame, suitable for ensuring the proper retention of the item within the frame itself.

Also in this embodiment, the device 21 is shaped so that a seat or housing for a protective film, namely for an electrostatic adhesion protective film, can be defined on the frame 23b, on the inner side with respect to the delimiting block 25.

If the item comprises function keys along its perimeter (as often happens in the case, for instance, of mobile phones and tablets), correspondingly shaped recesses 27 can be provided in the frame formed by the delimiting block 25, so as to more firmly hold the item in the correct position.

It is to be noted that in this third embodiment the device 21 for applying protective films is suitable for being integrated in the packaging of the item onto which the protective film is to be applied.

In other words, the item can be sold to the user inside the device 21, which has both the function of packaging during the shipping and storage of the item before the and the function of applying the protective film after sale.

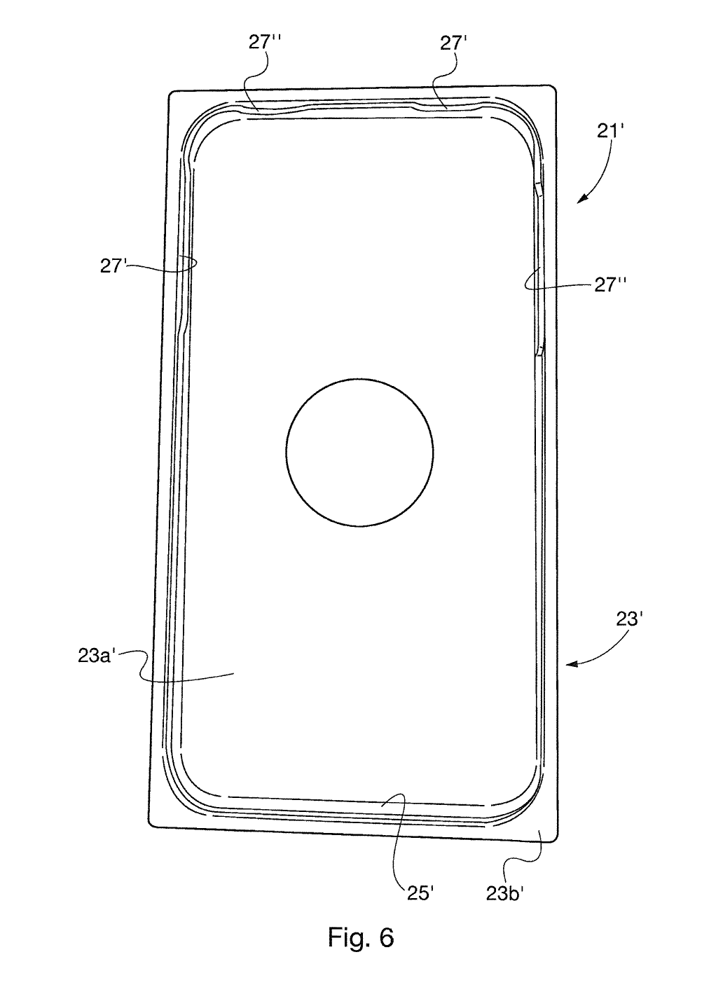

In FIG. 6, a variant of the third embodiment of the invention shown in FIG. 5 is illustrated.

Also in this variant, the device 21′ includes a mount 23′ comprising an outer perimeter frame 23b′ and a background wall 23a′; it further comprises a single delimiting block 25′ extending along the whole perimeter of the frame 23b′ and substantially forming a second raised frame, provided with shaped recesses 27′ arranged so as to house the function keys provided along the perimeter of the item onto which the protective film is to be applied.

In the variant of FIG. 6, in order to allow application of a second protective film onto the rear side of the item in question, second shaped recesses 27″ are provided in the delimiting block 25 in addition to the shaped recesses 27′; in this way, the item can be properly held inside the device 21′ in either orientation.

From the above description it will be therefore evident that the invention achieves the objects set forth above.

It will also be evident that the embodiments described above and illustrated in the accompanying drawings have been given by way of non-limiting example and that several variants and modifications are conceivable without departing from the scope of protection as defined by the appended claims.

1. Device (1; 11; 21; 21′) for applying a protective film onto the surface of an item, said device comprising:
a mount (3; 13; 23; 23′) comprising an outer perimeter frame (3b; 13b; 23b; 23b′), the shape of the item onto which the protective film is to be applied or a portion thereof being defined within said outer perimeter frame;
one or more delimiting blocks (5; 15; 25; 25′) arranged along the perimeter of said frame (3b; 13b; 23b; 23b′) and protruding therefrom, so that said item can be held within said frame (3b; 13b; 23b; 23b′).

2. Device (1; 21; 21′) according to claim 1, wherein said frame (3; 23; 23′) further comprises a background wall (3a; 23a; 23a′) extending within said outer perimeter frame (3b; 23b; 23b′).

3. Device (1; 21; 21′) according to claim 1, wherein the whole shape of said item is defined within said frame (3b; 23b; 23b′).

4. Device (11) according to claim 1, wherein a portion of the shape of said item is defined within said frame (13b).

5. Device (1; 11) according to claim 1, wherein said device comprises a plurality of said delimiting blocks (5; 15) discretely arranged along the perimeter of said frame (3b; 13b).

6. Device (21; 21′) according to claim 1, wherein said device comprises a single delimiting block (25; 25′) extending along the whole perimeter of said frame, or along a substantial portion thereof.

7. Device (1; 11; 21; 21′) according to claim 1, wherein a seat or housing for a film is defined within said frame (3b; 23b; 23b′), on the inner side with respect to said one or more delimiting blocks (5; 15; 25; 25′).

8. Device (1; 11; 21; 21′) according to claim 7, wherein said film is an electrostatic adhesion film.

9. Use of the device (1; 11; 21; 21′) according to claim 1 for applying a protective film onto the display of an electronic device, such as a mobile phone, a tablet personal computer or the like.
